(19) United States
(12) Patent Application Publication
(10) Pub. No.: US 2010/0007642 A1
(43) Pub. Date: Jan. 14, 2010

(54) Display Device and Related Computer Device

(76) Inventors: Yao-Tsung Chang, Taipei Hsien (TW); Pin-Hsien Su, Taipei Hsien (TW); Chia-Hsien Li, Taipei Hsien (TW); Chu-Chia Tsai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/247,214

(22) Filed: Oct. 7, 2008

(30) Foreign Application Priority Data
Jul. 9, 2008 (TW) 097125932

(51) Int. Cl. G06F 3/038

(52) U.S. Cl. 345/211

(57) ABSTRACT

A display device includes an image processing unit, a display unit, a power converter, and a transmission unit. The image processing unit is utilized for performing an image process on an image data generated by an electronic device. The display unit is coupled to the image processing unit for displaying the image data in real-time after the image process. The power converter is utilized for converting an external power generated by the electronic device to drive the image processing unit and the display unit. The transmission unit comprises a power port coupled to the power converter and the electronic device for receiving the external power.

### BACKGROUND OF THE INVENTION

1. Field of the Invention

The present invention relates to a display device and a related computer device, and more particularly, to a display device and a related computer device for receiving both power and data from an electronic device.

2. Description of the Prior Art

A conventional display device, such as a liquid crystal display (LCD) monitor or a projector, uses separate cables for power and signal transmission, wherein the cable for signal transmission is connected to the conventional display device via a connector that is defined according to type of video interface, such as Video Graphics Array (VGA), Composite Video Broadcast Signal (CVBS) or High Definition Multimedia Interface (HDMI).

With growing demand for displaying multimedia files in daily life, the display device almost becomes a necessity, and user convenience is an important consideration when people purchase the display device. As mentioned previously, the conventional display device uses separate cables for power and signal transmission, which results in inflexibility of device location. Therefore, user convenience is reduced.

### SUMMARY OF THE INVENTION

It is therefore a primary objective of the claimed invention to provide a display device and a related computer device, for enhancing user convenience.

The present invention discloses a display device comprising an image processing unit, a display unit, a power converter, and a transmission unit. The image processing unit is utilized for performing an image process on an image data generated by an electronic device. The display unit is coupled to the image processing unit, for displaying the image data in real-time after the image process. The power converter is utilized for converting an external power generated by the electronic device to drive the image processing unit and the display unit. The transmission unit comprises a power port coupled to the power converter and the electronic device for receiving the external power.

The present invention further discloses a computer device having displaying function comprising a central processing unit, a memory unit and a display device. The central processing unit is utilized for processing and controlling an image data generated by an electronic device. The memory unit is coupled to the central processing unit, for storing the image data. The display device is coupled to the central processing unit and comprises an image processing unit, a display unit, a power converter and a transmission unit. The image processing unit is utilized for performing an image process on the image data. The display unit is coupled to the image processing unit, for displaying the image data in real-time after the image process. The power converter is utilized for converting an external power generated by the electronic device to drive the image processing unit and the display unit. The transmission unit comprises a power port coupled to the power converter and the electronic device for receiving the external power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 6 are schematic diagrams of display devices according to embodiments of the present invention.

FIG. 7 is a schematic diagram of a computer device according to an embodiment of the present invention.

### DETAILED DESCRIPTION

The present invention aims to provide a display device using an integrated cable for power and signal transmission, for enhancing user convenience.

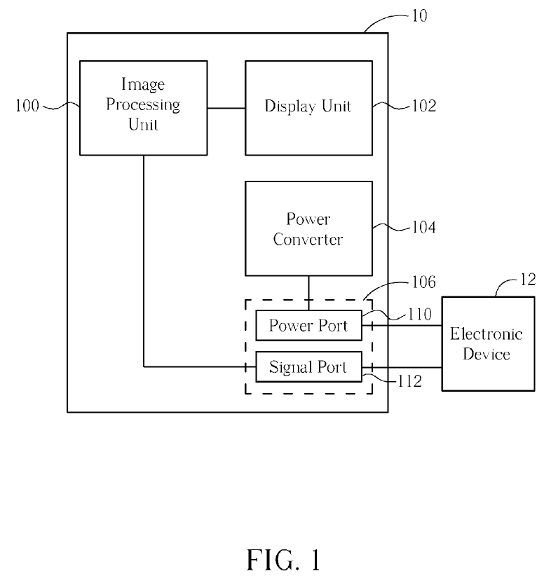

Please refer to FIG. 1, which is a schematic diagram of a display device 10 according to an embodiment of the present invention. The display device 10 can be an LCD monitor or a projector, for displaying image data generated by an electronic device 12. The display device 10 comprises an image processing unit 100, a display unit 102, a power converter 104 and a transmission unit 106. The image processing unit 100 is utilized for performing an image process on the image data generated by the electronic device 12 that makes the image data have a readable format for the display device 10. The display unit 102 is coupled to the image processing unit 100 and is utilized for displaying the image data in real-time after the image process performed by the image processing unit 100. The power converter 104 is utilized for converting external power generated by the electronic device 12 to power of the display device 10, for driving the image processing unit 100 and the display unit 102. The transmission unit 106 is a transmission interface for power and signal transmission, and comprises a power port 110 and a signal port 112. The power port 110 is coupled to the power converter 104 and the electronic device 12, for receiving the external power from the electronic device 12. The signal port 112 is coupled to the image processing unit 100 and the electronic device 12, for receiving the image data from the electronic device 12 and transmitting the image data to the image processing unit 100.

From the above, the power of the display device 10 is generated by the electronic device 12 that also generates the image data. Therefore, transmission cables for power and signal transmission for the display device 10 can be integrated in one cable, which is coupled between the transmission unit 106 and the electronic device 12. Location of the display device 10 is more flexible as a result of having only one cable, and thereby user convenience of the display device 10 is enhanced.

The display device 10 can be an LCD monitor or a projector. In addition, the electronic device 12 can be a computer, a mobile phone, a personal digital assistant (PDA) or a digital photo frame. Taking a projector as the display device 10 and a computer as the electronic device 12 for example, the projector receives the image data such as pictures or video files from the computer via the signal port 112, and transmits the image data to the image processing unit 100. The image processing unit 100 performs an image process on the image data, and finally the image data is displayed on a projection screen via the display unit 102. At the same time, the projector receives power from the computer via the power port 110, and then converts the received power via the power converter 104, to generate power properly for use by the projector.

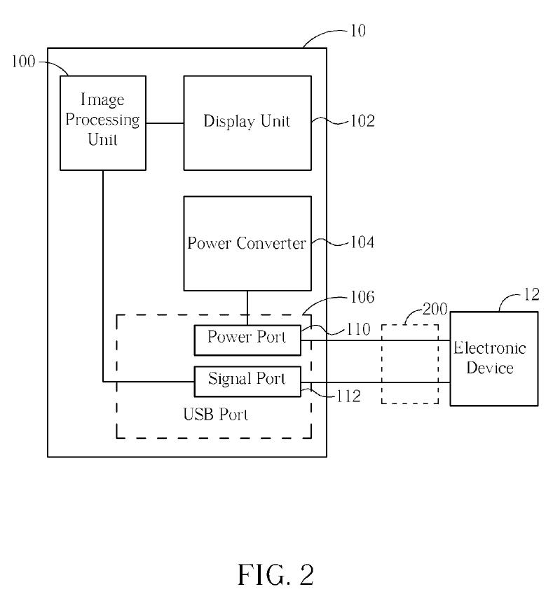

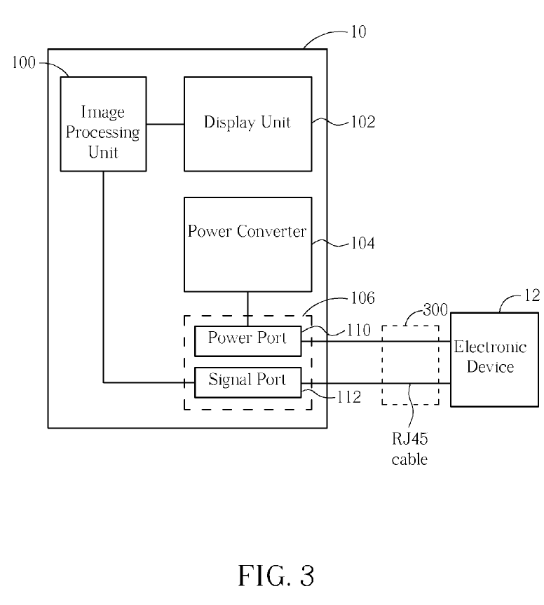

Please refer to FIG. 2 and FIG. 3, which are schematic diagrams of the display device 10 according to other embodiments of the present invention. In FIG. 2, the transmission unit 106 is a Universal Serial Bus (USB) port, wherein the power port 110 and the signal port 112 are different pins of the USB port. The transmission unit 106 connects to the electronic device 12 via a USB cable 200. In FIG. 3, the signal port 112 is an Ethernet port connecting the display device 10 to the electronic device 12 via a standard RJ45 (or CAT-3) cable, and the power port 110 connects the display device 10 to the electronic device 12 via a power cable. The RJ45 cable and the power cable are integrated into a transmission cable 300. Please note that the USB cable 200 and the transmission cable 300 are embodiments of the present invention, and types of cables are not limited to USB cables or any other cable.

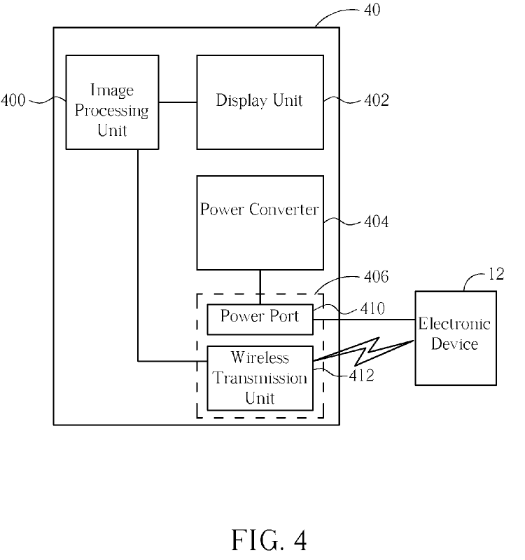

The display device 10 is one of embodiments of the present invention, and those skilled in the art can make alterations and modifications accordingly. For example, wireless transmission techniques can be applied in embodiments of the present invention. Please refer to FIG. 4, which is a schematic diagram of a display device 40 according to an embodiment of the present invention. The display device 40 comprises an image processing unit 400, a display unit 402, a power converter 404 and a transmission unit 406. Operations of the image processing unit 400, the display unit 402 and the power converter 404 are the same as similar units in the display device 10, and are not repeated here. The transmission unit 406 comprises a power port 410 and a wireless transmission unit 412. In FIG. 4, the power port 410 is coupled to the power converter 404 and the electronic device 12 for receiving a power generated by the electronic device 12. The wireless transmission unit 412 is coupled to the image processing unit 400 and the electronic device 12 for wirelessly receiving the image data from the electronic device 12 and then transmitting the image data to the image processing unit 400. Note that the wireless transmission unit 412 can wiredly transmit or wirelessly transmit the image data to the image processing unit 400.

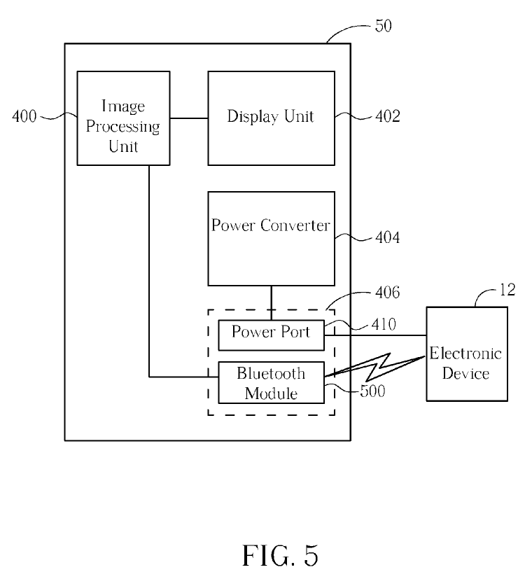

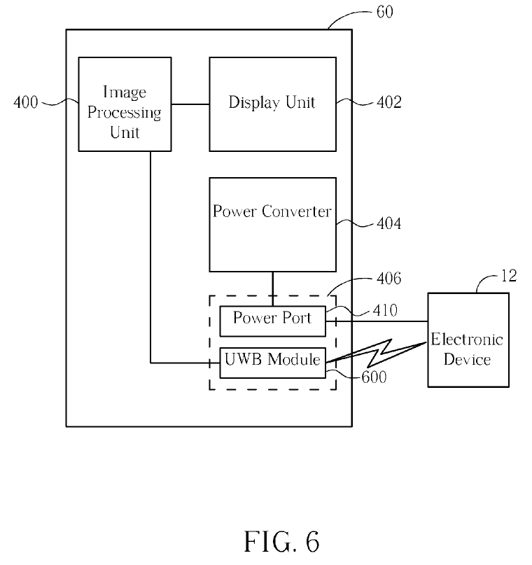

In addition, the wireless transmission unit 412 is implemented according to the selected wireless transmission technique. Please refer to FIG. 5 and FIG. 6, which are schematic diagrams of display devices 50 and 60 according to embodiments of the present invention. The display devices 50 and 60 are similar to the display device 40, wherein a Bluetooth module 500 in the display device 50 and an Ultra Wideband (UWB) module 600 in the display device 60 are different implementations of the wireless transmission unit 412 in the display device 40. Therefore, the embodiment of the present invention can wirelessly receive the image data.

In summary, the display device 10 is wiredly coupled to the electronic device 12 and also wiredly receives both power and the image data from the electronic device 12; the transmission cables of the display device 10 can be integrated into one cable. The display device 40 is coupled to the electronic device 12 for wiredly receiving power and wirelessly receiving the image data from the electronic device 12.

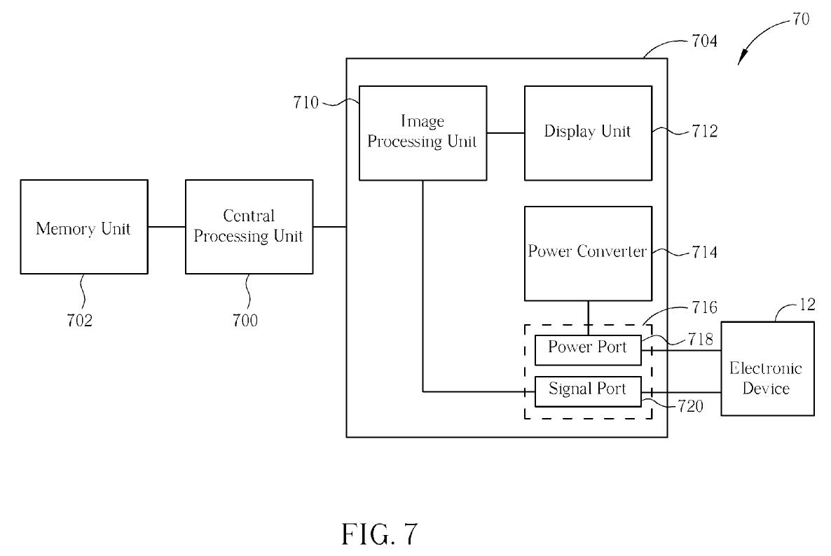

Furthermore, the display device 10 or the display device 40 can be applied in a computer device. Please refer to FIG. 7, which is a schematic diagram of a computer device 70 according to an embodiment of the present invention. The computer device 70 comprises a central processing unit 700, a memory unit 702 and a display device 704. The central processing unit 700 is utilized for processing and controlling image data generated by the electronic device 12. The memory unit 702 is coupled to the central processing unit 700 for storing the image data. The display device 704 is coupled to the central processing unit 700 and comprises an image processing unit 710, a display unit 712, a power converter 714 and a transmission unit 716. The image processing unit 710 is utilized for performing an image process on the image data. The display unit 712 is coupled to the image processing unit 710 for displaying the image data in real-time after the image process. The power converter 714 is utilized for converting external power generated by the electronic device 12 to drive the image processing unit 710 and the display unit 712. The transmission unit 716 comprises a power port 718 and a signal port 720, wherein the power port 718 is coupled to the power converter 714 and the electronic device 12 for receiving the external power; the signal port 720 is wiredly coupled to the image processing unit 710 and the electronic device 12 for receiving the image data from the electronic device 12 and then transmitting the image data to the image processing unit 710.

Please refer to FIG. 1 to FIG. 3 for understanding of relationships of the power port 718 and the signal port 720 and other units. In the computer device 70, the display device 704 wiredly receives both power and the image data from the electronic device 12, and the transmission cables of the display device 704 can be integrated into one cable. Therefore, a user can conveniently place and use the computer device 70 without the inconvenience resulting from separate transmission cables. Similarly, the display device 40 can also be applied in a computer device. Thus, the computer device can wirelessly receive image data from an electronic device from which the display device 40 receives power. Please refer to FIG. 4 to FIG. 7 for illustration of implementations, which is not repeated here.

In conclusion, the display device according to the present invention receives power from the electronic device from which the display device receives image data, and therefore the transmission cables of the display device can be integrated. In addition, the display device according to the present invention can wirelessly receive the image data. As a result, user convenience of the display device is enhanced.

Those skilled in the art will readily observe that numerous modifications and alterations of the device and method may be made while retaining the teachings of the invention.

What is claimed is:

1. A display device comprising:
an image processing unit, for performing an image process on an image data generated by an electronic device;
a display unit, coupled to the image processing unit, for displaying the image data in real-time after the image process;
a power converter, for converting external power generated by the electronic device to drive the image processing unit and the display unit; and
a transmission unit, comprising a power port coupled to the power converter and the electronic device for receiving the external power.

2. The display device of claim 1, wherein the transmission unit further comprises a signal port wiredly coupled to the image processing unit and the electronic device for receiving the image data from the electronic device and transmitting the image data to the image processing unit.

3. The display device of claim 2, wherein the transmission unit is a USB port.

4. The display device of claim 2, wherein the signal port is an Ethernet port.

5. The display device of claim 1, wherein the transmission unit further comprises a wireless transmission unit coupled to the image processing unit and the electronic device for wirelessly receiving the image data from the electronic device and transmitting the image data to the image processing unit.

6. The display device of claim 5, wherein the wireless transmission unit wiredly transmits the image data to the image processing unit.

7. The display device of claim 5, wherein the wireless transmission unit wirelessly transmits the image data to the image processing unit.

8. The display device of claim 5, wherein the wireless transmission unit is an Ultra Wideband (UWB) module or a Bluetooth module.

9. The display device of claim 1, wherein the electronic device is a computer, a mobile phone, a personal digital assistant or a digital photo frame.

10. The display device of claim 1, wherein the display device is a projector or a flat panel display device.

11. A computer device having a displaying function, the computer device comprising:
a central processing unit, for processing and controlling image data generated by an electronic device;
a memory unit, coupled to the central processing unit, for storing the image data; and
a display device, coupled to the central processing unit, the display device comprising:
an image processing unit, for performing an image process on the image data;
a display unit, coupled to the image processing unit, for displaying the image data in real-time after the image process;
a power converter, for converting external power generated by the electronic device to drive the image processing unit and the display unit; and
a transmission unit, comprising a power port coupled to the power converter and the electronic device for receiving the external power.

12. The computer device of claim 11, wherein the transmission unit further comprises a signal port wiredly coupled to the image processing unit and the electronic device for receiving the image data from the electronic device and transmitting the image data to the image processing unit.

13. The computer device of claim 12, wherein the transmission unit is a USB port.

14. The computer device of claim 12, wherein the signal port is an Ethernet port.

15. The computer device of claim 11, wherein the transmission unit further comprises a wireless transmission unit coupled to the image processing unit and the electronic device, for wirelessly receiving the image data from the electronic device and transmitting the image data to the image processing unit.

16. The computer device of claim 15, wherein the wireless transmission unit wiredly transmits the image data to the image processing unit.

17. The computer device of claim 15, wherein the wireless transmission unit wirelessly transmits the image data to the image processing unit.

18. The computer device of claim 15, wherein the wireless transmission unit is an Ultra Wideband (UWB) module or a Bluetooth module.

19. The computer device of claim 11, wherein the electronic device is a computer.

20. The computer device of claim 11, wherein the display device is a projector or a flat panel display device.
